(19) United States
(12) Patent Application Publication
(10) Pub. No.: US 2015/0111073 A1
(43) Pub. Date: Apr. 23, 2015

(54) BATTERY PACK UNIT INTEGRATING BUS BAR UNIT, CELL MONITOR SUBSTRATE AND CONTROL UNIT

(71) Applicant: DENSO CORPORTION, Kariya-city (JP)

(72) Inventors: Masashi DERIHA, Kariya-shi (JP); Shunichi MIZOBE, Kariya-shi (JP); Hayato MIZOGUCHI, Kariya-shi (JP); Tomomichi MIZOGUCHI, Inazawa-shi (JP)

(21) Appl. No.: 14/520,498

(22) Filed: Oct. 22, 2014

(30) Foreign Application Priority Data
Oct. 22, 2013 (JP) 2013-219669

(51) Int. Cl. H01M 2/10; H01M 10/42; H01M 10/04; H01M 2/20

(52) U.S. Cl. CPC H01M 2/1072; H01M 2/206; H01M 10/425; H01M 10/0413; H01M 2220/20
USPC 429/61

(57) ABSTRACT

A battery pack unit includes: a plurality of battery cells each having an electrode; a battery pack constituted by the plurality of battery cells being laminated in a lamination direction; an electrode connecting member electrically connecting electrodes of mutually adjacent battery cells; a cell monitor substrate that monitors a state of every battery cell and a control unit electrically connected to the cell monitor substrate, receiving a signal transmitted from the cell monitor substrate. The cell monitor substrate and the control unit are arranged in the lamination direction and arranged in parallel with the electrode connecting member at a side of the electrode surface.

### CROSS-REFERENCE TO RELATED APPLICATION

This application is based on and claims the benefit of priority from earlier Japanese Patent Application No. 2013-219669 filed Oct. 22, 2013, the description of which is incorporated herein by reference.

### BACKGROUND

1. Technical Field

The present disclosure relates to a battery pack unit provided with a battery pack in which a plurality of battery cells are laminated.

2. Description of the Related Art

The battery pack unit used for a vehicle is constituted by a battery pack and a cell monitor substrate which are integrated with each other. The battery pack includes a plurality of battery cells and the cell monitor substrate monitors physical state such as temperature and voltage for respective battery cells. The voltage and the temperature detected by the cell monitor substrate are outputted to a control unit. The control unit is adapted to control, based on the voltage and the temperature of the respective battery cells, the state of the battery pack. Also, the control unit is communicable with other ECUs mounted in a vehicle when being used for the vehicle. In such a battery pack unit, the control unit has been considered to be integrated with the battery pack. For example, the following patent document has been disclosed.

Specifically, Japanese Patent Application Laid-Open Publication No. 2013-30312 discloses a battery pack unit including a battery module (i.e., battery pack), a bus bar module and a battery state notifying unit (i.e., cell monitor substrate). The battery module is constituted by a plurality of battery cells laminated from each other. The bus bar module includes a bus bar used for connecting electrodes corresponding to the respective battery cells in the battery module. The battery state notifying unit is connected to the bus bar module. In the battery module, the bus bar module is mounted on the same surface side on which the electrodes corresponding to the respective battery cells are disposed. In this case, the area of the electrode surface side of the battery module in planar view and the area of the bus bar module in planar view are substantially the same and terminals of the electrodes are protruded upward from the bus bar (i.e., bus bar used for mutually connecting respective electrodes) of the bus bar module. Further, the battery state notifying unit is electrically connected to the electrodes corresponding to the respective battery cells via the bus bar (i.e., bus bar used for connecting substrate). In the battery module, the battery state monitoring unit (i.e., control unit) is mounted on a side surface of the battery module.

However, according to the above-described configuration, in the battery module, the battery state notifying unit and the battery state monitoring unit are disposed on mutually different surfaces, thereby causing a difficulty when the battery module is required to be shrunk. Moreover, with a configuration in which the battery state monitoring unit is disposed on a side surface of the battery module, when other equipment (including other battery modules) is disposed in the vicinity of the battery module, it is considered that the battery state monitoring unit causes an obstruction to saving of the battery module.

### SUMMARY

The embodiment provides a configuration of the battery pack unit having an advantage of shrinking and saving space required for the battery pack unit.

As an aspect of the present disclosure, a battery pack unit includes: a plurality of battery cells each having an electrode and a side surface; a battery pack constituted by the plurality of battery cells being laminated in a lamination direction wherein the side surface of each battery cell faces the side surface of a battery cell being adjacent to the each battery cell and, the electrode of the each battery cell and the electrode of the battery cell being adjacent to the each battery cell are arranged in the same side thereof; an electrode connecting member disposed at a side of an electrode surface of the battery pack in which electrodes of the plurality of battery cells are arranged, the electrode connecting member electrically connecting electrodes of mutually adjacent battery cells in the plurality of battery cells, thereby connecting the plurality of battery cells to be in series; a cell monitor substrate that monitors a state of every battery cell in the plurality of battery cells; and a control unit electrically connected to the cell monitor substrate, receiving a signal transmitted from the cell monitor substrate. The cell monitor substrate and the control unit are arranged in the lamination direction and arranged in parallel with the electrode connecting member at the side of the electrode surface.

According to the above-described disclosure, in the battery pack unit where a plurality of battery cells are laminated, electrodes of the respective battery cells are arranged in a row towards a direction where the battery cells are laminated and adjacent electrodes of the plurality of battery cells are electrically connected by the electrode connecting member. The cell monitor substrate and the control unit are arranged to be in lateral to the electrode connecting member, whereby available space at a lateral side of the electrode connecting member can be utilized well so that the cell monitor substrate and the control unit can be appropriately arranged. In other words, the electrode connecting member is disposed at one side of the battery pack unit to be protruded therefrom and, the cell monitor substrate and the control unit are arranged at a lateral side of the electrode connecting member. As a result, as an overall battery pack unit, the battery pack unit can be suppressed from protruding excessively towards outside thereof and can be shrunk as well. Moreover, the cell monitor substrate and the control unit are arranged collectively at one surface side of the battery pack whereby the battery pack unit is unlikely to protrude towards a lateral side thereof. Hence, according to this configuration, it is preferable to configure a power storage device by using a plurality of battery pack units or to arrange other equipment closely to the battery pack unit. In other words, the configuration as described above has an advantage when saving space of a battery pack unit.

### BRIEF DESCRIPTION OF THE DRAWINGS

In the accompanying drawings:

FIG. 1 is a diagram showing a perspective view of the battery pack unit;

FIG. 2 is a diagram showing a top view of the battery pack unit;

FIG. 3 is a diagram showing an enlarged view of the upper surface of the battery pack unit;

FIG. 4 is an explanatory diagram showing a configuration of the battery cell;

FIG. 5 is an explanatory diagram showing an arrangement of the respective substrates and the connectors; and

FIG. 6 is an explanatory diagram showing a connection state of the respective substrates.

### DETAILED DESCRIPTION OF THE PREFERRED EMBODIMENTS

### Embodiment

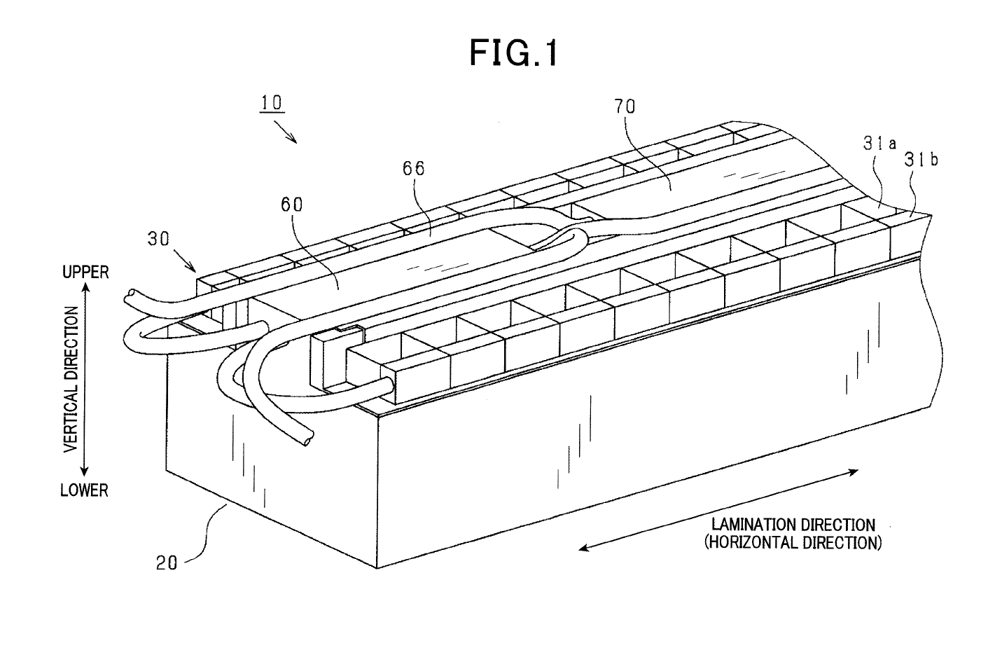

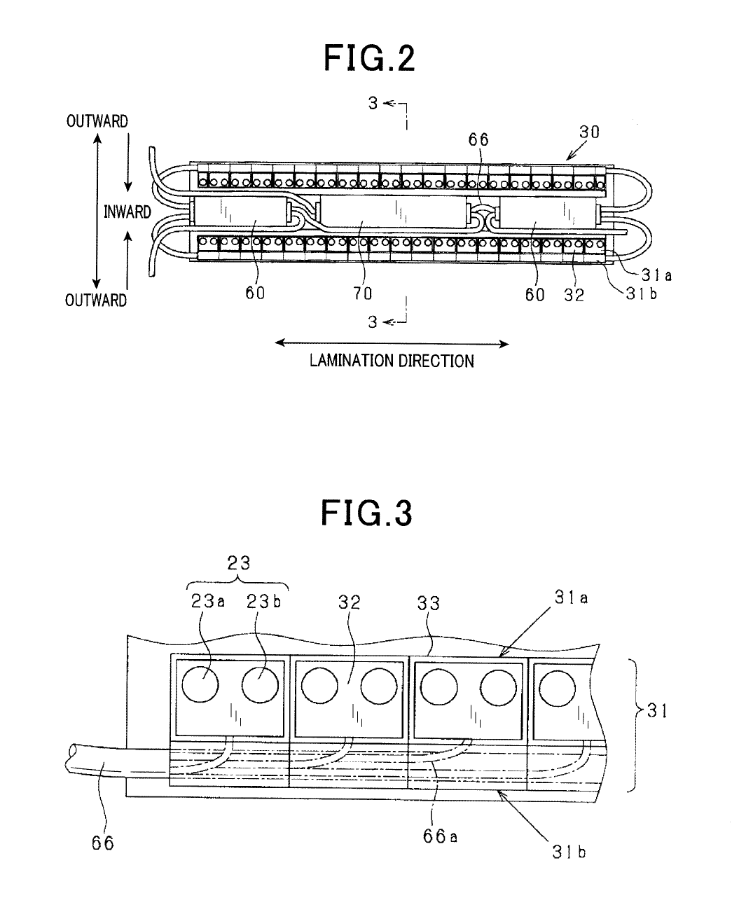

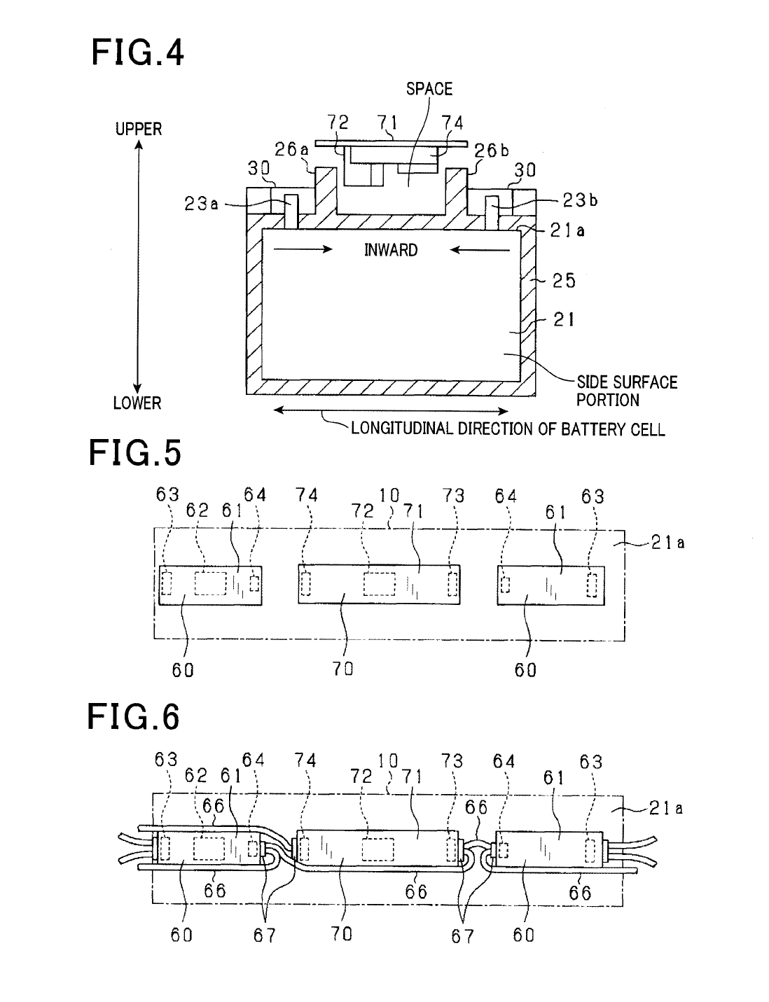

With reference to the drawings, hereinafter, it is described an embodiment in which the present disclosure is embodied. FIG. 1 illustrates a perspective view showing a configuration of the battery pack unit 10. FIG. 2 illustrates a planar view of the battery pack unit 10 which is viewing from the upper surface thereof. FIG. 3 is a diagram in which the top view of the battery pack 10 is partly enlarged. FIG. 4 is a diagram showing cross sectional view taken from line 3-3 of the battery pack unit 10 as shown in FIG. 2.

The battery pack unit 10 is provided with a battery pack 20 constituted by a plurality of single battery cells (i.e., battery cell 21), an electrode connecting member (i.e., bus bar unit 30) that electrically connects a plurality of battery cells 21 constituting the battery pack 20, a cell monitor substrate 60 that monitors a state of the battery cell 21 and a control unit 70 that receives a signal transmitted from the cell monitor substrate 60. According to the battery pack unit 10 configured as described above, the respective units are arranged to be faced each other in the vertical direction (upper-lower direction) such that the battery pack 20 is disposed in the bottom side (lower side) and the bus bar unit 30, the cell monitor substrate 60 and the control unit 70 are disposed in the upper side.

Regarding the battery cell 21, as shown in FIG. 4, the battery cell 21 includes a pair of electrodes 23 (i.e., positive terminal 23a and negative terminal 23b) and is disposed in a housing case 25 to be accommodated thereby. The battery cell 21 has a thin rectangular-parallelepiped shape and includes a side surface portion and an end surface portion. The side surface portions of the respective battery cells 21 face one another when the battery cells 21 are laminated. The end surface portion has a rectangular shape, which is perpendicular to the side surface portion.

The electrode terminal 23 includes the positive terminal 23a and the negative terminal 23b which are disposed at opposite end portions in the longitudinal direction of an upper end surface portion (hereinafter referred to electrode surface 21a). The electrode terminal 23 is a column shaped member which is formed by electric conductive material such as metal and being formed to have its length such that the electrode terminal 23 protrudes outside from the housing case 25 under a condition that the housing case 25 accommodates the battery cell 21.

The housing case 25 is made of insulating material such as resin and having a shape to cover the entire outer periphery of the battery cell 21. Further, protrusions 26a and 26b are formed on a side of the electrode surface 21a to couple a plurality of battery cells 21 to be integrated with each other. The protrusions 26a and 26b are portions each having a convex shape being made of a material same as the housing case 25. The protrusions 26a and 26b are disposed to be apart from each other and disposed inward the pair of electrodes 23. In particular, the protrusion 26a is disposed adjacently to the positive terminal 23a and the protrusions 26b are disposed adjacently to the negative terminal 23b. It is noted that the protrusions 26a and 26b correspond to the protrusion.

Regarding the battery pack 20, the battery pack 20 is constituted by laminating a plurality of battery cells 21. In this case, the plurality of battery cells are laminated such that the side surface of the battery cell 21 faces the side surface of an adjacent battery cell 21 and, the positive terminal 23a and the negative terminal 23b are arranged in the same side (upper surface side). Moreover, the battery cells 21 are laminated such that the positive terminal 23a and the negative terminal 23b are arranged alternately in the same side of the end portion of the electrode surface 21a. The electrode terminals 23 arranged successively on the battery pack 20 are electrically connected by a bus bar unit 30 (described later). It is noted that the direction along which the plurality of battery cells 21 are limited is defined as a lamination direction.

When the battery cells 21 are laminated, the protrusions 26a and 26b are arranged to be adjacent to the rows of the electrode terminals 23a and 23b respectively.

According to the embodiment, a pair of protrusions 26a and 26b disposed on the side of the electrode surface 21a of the battery pack forms space on the side of the electrode surface 21a. In the space, various substrates or wirings (described later) are disposed.

Regarding the bus bar unit 30, as shown in FIGS. 2 and 3, the bus bar unit 30 is provided with a bus bar 32 that electrically connects the electrodes 23 of the battery cells 21 which are located adjacently to each other and a bus bar casing 31 in which a plurality of bus bars 32 are arranged in a row and a wiring 66a extended from the electrode terminal 23 via the bus bar 32 is disposed.

The bus bar 32 is a plate like member having substantially rectangular shape and made of electric conductive material such as metal. A pair of through holes (reference number is omitted) that allow the electrode terminal 23 to penetrate thereto are formed at both ends (opposite ends) of the bus bar 32 in the longitudinal direction thereof. The positive terminal 23a and the negative terminal 23b of mutually adjacent battery cells 21 penetrate the respective through holes of the bus bar 32 whereby the mutually adjacent battery cells 21 are electrically connected in series.

The bus bar casing 31 is a member having substantially rectangular parallelepiped shape and the length thereof is the same as that of the battery pack 20 (length in the thickness direction of the laminated battery cells 21). The bus bar casing 31 includes a bus bar accommodating member 31a that accommodates the bus bar 32 and a wiring accommodating member 31b. The bus bar casing 31 is mounted to the battery pack 20 such that the bus bar accommodating member 31a is disposed inward the bus bar unit 30 and the wiring accommodating member is disposed outward the bus bar unit 30. An opening (not shown) is disposed between the wiring accommodating member 31b and the bus bar accommodating member 31a so that the wiring 66a extended from the electrode terminal 23 arranged in the bus bar casing 31 is collected in the wiring accommodating member 31b.

The bus bar unit 30 as described above is mounted to respective rows of the electrode terminal 23 arranged at both ends of the battery pack 20. In this case, the bus bar 32 arranged in the bus bar casing 31 connects both electrode terminals 23 being adjacent to each other. Moreover, the wiring extended from the respective bus bar casing 31 is collected in the wiring accommodating member 31b and integrated by an insulating material.

Thus, when the bus bar casing 30 is employed, the bus bars 32 are connected together to the plurality of battery cells 21 which are laminated. In this configuration, the bus bar unit 30 is disposed so as to protrude towards one surface side of the battery pack 20, whereby space is formed between a pair of bus bar units 30 (in a lateral side). According to the embodiment, space sandwiched by the protrusion 26a and the protrusion 26b are formed inside the bus bar unit 30.

FIG. 5 is a planar view showing the cell monitor substrate 60 and the control unit 70 disposed in the battery pack unit 10. Regarding the cell monitor substrate 60, as shown in FIG. 5, the cell monitor substrate 60 is provided with a substrate member 61, an electrical component 62, a connector 63 and a connector 64. The electrical component 62 is constituted by a voltage detecting circuit and a multiplexer, and mounted on one surface of the substrate member 61. The connector 63 and the connector 64 serve as a battery connector 63 which is electrically connected to the battery pack 20 and a substrate connector 64 for connecting to other substrate respectively. The substrate connector 64 is electrically connected to other substrates other than own substrate. These connectors 63 and 64 are mounted on a surface on which the electrical component of the substrate member 61 is mounted.

When the connectors 63 and 64 are disposed at opposite ends of the substrate member 61 respectively, the respective connectors 63 and 64 can be arranged appropriately on the substrate member 61 without expanding size of the substrate member 61. In particular, since the battery connector 63 is used as a voltage detecting connector for detecting the cell voltage as well, the size of connector is likely to be larger. However, even when such a large connector is required to be surface-mounted, the embodiment of the present disclosure can be adapted to such a large connector. It is noted that a surface-mounted type connector (SMD (surface-mount device) connector) has been used as a connector according to the embodiment.

FIG. 6 is an explanatory diagram showing a connecting state in which the cell monitor substrate 60 and the control unit 70 are connected. As shown in FIG. 6, the connector is constituted by a combination of a mounting portion (e.g., female connector) and a non-mounting portion (e.g., male connector). Moreover, the connector is constituted such that the connector 67 of the non-mounting portion disposed on the wire harness 66 is capable of attaching/detaching from/to the mounting portion disposed at the substrate side. According to the embodiment, the connector 67 is disposed at the both ends (opposite ends) of the wiring 66 that electrically connects the respective substrates.

The cell monitor substrate 60 monitors states corresponding to a predetermined number of battery cells 21. Hence, a plurality of cell monitor substrates 60 corresponding to the number of battery cells 21 which constitute the battery pack 20 are arranged. According to the embodiment, the cell monitor substrates 60 are two in number.

(Control Unit 70)

The control unit 70 is constituted by a substrate member 71, an electrical component 72, a connector 73 and a connector 74. The electrical component 72 is a component such as CPU or a power device and mounted on one surface of the substrate member 71. The connectors 73 and 74 are provided with a separated substrate connector 73 which is electrically connected to the cell monitor substrate 60 and an other substrate connector 74 which is electrically connected to equipment other than the battery pack 20, respectively. These connectors 73 and 74 are mounted on a surface on which the electrical component 72 is mounted.

The connector 73 and 74 are arranged at respective ends of the substrate member 71 in the longitudinal direction. In the control unit 70, the respective connectors 73 and 74 are arranged at opposite ends of the substrate member 71 so that the connectors 73 and 74 can preferably be arranged without expanding the size of the substrate member 71. It is noted that the respective connectors 73 and 74 are made by using the surface-mounted type connector.

The cell monitor substrate 60 and the control unit 70 having configurations as described above are arranged such that the direction along which the respective connectors are arranged is set as the longitudinal direction of the battery pack 20. In this case, as shown in FIG. 4, the cell monitor substrate 60 and the control unit 70 are supported by an upper portion of the protrusions 26a and 26b. The protrusions 26a and 26b are disposed at the electrode surface 21a side between the pair of bus bar units 30. In this case, the respective substrate members 61 and 71 are disposed such that the surface on which the respective electrical components and the respective connectors are mounted faces towards the battery cell 21. Hence, by disposing the protrusions 26a and 26b, components having high height such as connectors can be arranged in available space disposed on the electrode surface 21a.

Thus, according to the configuration having a pair of protrusions 26a and 26b disposed outside the battery pack, a mounted surface of the substrate members 61 and 71 are disposed downward in the available space between the pair of protrusions 26a and 26b. Hence, the available space between the protrusion 26a and the protrusion 26b is effectively utilized so that tall components such as connectors can preferably be disposed. As a result, it is possible to reduce dead space in the space where the battery pack unit 10 is disposed.

According to the embodiment, it is exemplified that two cell monitor substrates 60 are mounted. In this case, the control unit 70 is disposed on the electrode surface 21a to be sandwiched by two cell monitor substrates 60. When a plurality of cell monitor substrates 60 are connected to one control unit 70, since the control unit 70 is disposed between the cell monitor substrates 60, the electrical connection between the cell monitor substrate 60 and the control unit 70 by the wiring 66 can more preferably be made.

The cell monitor substrate 60 and the control unit 70 adjacently disposed from each other are disposed to be apart from each other. In this case, the connecting portion of the substrate connector 64 disposed at the cell monitor substrate 60 and the connecting portion of the separated substrate connector 73 disposed at the control unit 70 are disposed to be faced each other. When the cell monitor substrate 60 and the control unit 70 are disposed to be apart from each other, a gap being made between the cell monitor substrate 60 and the control unit 70 can be used for attaching or detaching the wiring 66 from/to the cell monitor substrate 60 and the control unit 70. Therefore, the respective connectors at mounting portions of the substrates being adjacent from each other can be disposed closely and the respective connectors can readily be attached or detached.

As shown in FIG. 5, under a condition in which the cell monitor substrate 60 and the control unit 70 is disposed on the battery pack 20, the respective connectors included in the cell monitor substrate 60 and the control unit 70 are connected to the connector 67 of the wiring 66. That is, as shown in FIG. 6, the connector 67 of the wiring 66 is connected to the substrate connector 64 of the cell monitor substrate 60, and the connector 67 disposed at the other end of the wiring 66 is connected to the separated substrate connector 73 of the control unit 70. According to the embodiment, since two cell monitor substrates 60 are provided, the connector 67 disposed at the other end of the wiring 66 which is connected to the substrate connector 64 of the respective cell monitor substrates 60, is connected to the separated substrate connector 73.

In the embodiment, a wire harness electrically connects the cell monitor substrate 60 and the control unit 70. The wire harness can be bent freely so that the wire harness can be disposed freely in the remaining space as a result of disposing the substrates 60 and 70. Hence, it is not necessary to secure dedicated space for wirings to be disposed so that the protrusions 26a and 26b can be effectively utilized. Therefore, according to the embodiment, an advantageous configuration is made to save the space.

The battery connector 63 and the battery pack 20 are electrically connected via the connector 67 and the wiring 66 as well. Similarly, the other substrate connector 74 is electrically connected to a vehicle-side ECU via the connector 67 and the wiring 66.

Thus, when the cell monitor substrate 60, the control unit 70 are electrically connected each other via the wiring 66 and the connector 67, since the wiring 66 (wire harness) has a characteristic where the wiring can be bent freely, both the cell monitor 60 and the control unit 70 can be electrically connected appropriately without being influenced by the arrangement between the cell monitor substrate 60 and the control unit 70. For example, when comparing with a configuration of the conventional art in which the respective battery cells 21 and the cell monitor substrate 60 are electrically connected via the bus bar 32, according to the configuration of the conventional art, the size of the cell monitor substrate 60 is determined depending on locations of the electrodes in the respective battery cells 21. However, according to the embodiment of the present disclosure, by using the wiring 66 as a wire harness, the size of the cell monitor substrate 60 can be determined without depending on the locations of the electrodes in the respective battery cells 21. Hence, the cell monitor substrate 60 can be shrunk whereby the space for arranging both the cell monitor substrate 60 and the control unit 70 can be secured at an electrode surface 21a.

Since the first connector (i.e., connector disposed at the substrate) is disposed so as to make the direction along which the second connector (i.e., the connector disposed at the wire harness) is attached or detached, to be the direction along which the battery cells are laminated (i.e., lamination direction), work space for attaching or detaching the connectors can readily be secured. As a result, by using the work space, the connectors can preferably be attached or detached.

As described above, as an overall battery pack unit 10, the battery pack unit 10 can be suppressed from protruding excessively towards the lateral side thereof and can be shrunk as well. Moreover, the cell monitor substrate 60 and the control unit 70 are arranged collectively at one surface side of the battery pack 20 whereby the battery pack unit is unlikely to protrude towards a lateral side thereof. Hence, according to this configuration, it is preferable to configure a power storage device by using a plurality of battery pack units 10 or to arrange other equipment closely to the battery pack unit 10. In other words, the configuration as described above has an advantage when saving space around a battery pack unit.

According to the above-described configurations, the following advantages can be obtained.

(1) The cell monitor substrate 60 and the control unit 70 are arranged beside the bus bar unit 30. Accordingly, available space at a lateral side of the bus bar unit 30 can be utilized well so that the cell monitor substrate 60 and the control unit 70 can be appropriately arranged. In this case, as an overall battery pack unit 10, the battery pack unit 10 can be suppressed from excessively protruding towards outside thereof and can be shrunk as well. Further, the cell monitor substrate 60 and the control unit 70 are arranged collectively at one surface side of the battery pack 20 (i.e., at electrode surface 21a) whereby the battery pack unit is unlikely to protrude towards a lateral side of the battery pack unit 10. Hence, according to this configuration, it is preferable to configure a power storage device by using a plurality of battery pack unit 10 or to arrange other equipment closely to the battery pack unit 10. In other words, the configuration as described above has an advantage when saving space of a battery pack unit.

(2) According to a configuration by using the bus bar unit 30, the bus bars 32 can be collectively connected to the plurality of battery cells 21 which are laminated. In this configuration, available space between a pair of bus bar unit 30 can be utilized as a space for disposing a substrate, whereby the battery pack unit 20 can be shrunk.

(3) According to a configuration in which a pair of protrusions 26a and 26b are disposed outside the battery pack 20, available space can be formed between the pair of protrusions 26a and 26b. In this case, a mounted surface of connectors corresponding to the respective substrates is arranged downward in the battery pack unit 10 so that available space is well utilized to appropriately arrange components having high height.

(4) When the number of battery cells 21 that constitutes the battery pack 20 increases, a plurality of cell monitor substrates 60 are disposed corresponding to one battery pack unit 20. For example, when the cell monitor substrate 60 is provided for every predetermined number of units, the number of cell monitor substrate 60 increases based on an increase of the number of battery cell 21. In this case, a plurality of cell monitor substrates 60 are connected to one control unit 70. Hence, the control unit 70 is disposed between two cell monitor substrates 60 so that electrical connection between both cell monitor substrates can be made appropriately.

(5) According to a configuration in which the cell monitor substrate 60 and the control unit 70 are electrically connected to each other via the wiring 66 (i.e., wire harness), since the wire harness has a characteristic where the wiring can be bent freely, both the cell monitor 60 and the control unit 70 can be electrically connected appropriately without being influenced by the arrangement between the cell monitor substrate 60 and the control unit 70. Further, when the wire harness is employed, the size of the cell monitor substrate 60 can be determined without depending on the electrode position of the respective battery cells 21. As a result, the cell monitor substrate 60 can be shrunk, whereby the space for arranging both the cell monitor substrate 60 and the control unit 70 can be secured at the same surface of the battery pack 20.

(6) The space made between the cell monitor substrate 60 and the control unit 70 can be utilized as a space for attaching/detaching the connector 67 which is connected to the wiring 66. Hence, the connectors disposed at the respective substrates can be arranged closely from each other and moreover, the respective connectors can readily be attached/detached.

(7) The above-described respective connectors of the cell monitor substrate 60 are arranged at opposite ends of the cell monitor substrate 60 in the lamination direction of the battery cell 21. Therefore, without expanding size of the substrate member 61, appropriate arrangement of the respective connectors can be made. In particular, in this case, the battery connector 63 is also used as a connector for detecting cell voltage so that the size of the connector is likely to be larger. However, the configuration according to the present disclosure is suitable for such a relatively large connector to be surface-mounted. Further, when two connectors are arranged separately in an upper side and a lower side, it is considered that the lower-side connector is difficult to attach and detach. However, the configuration according to the present disclosure is able to avoid an occurrence of such an inconvenience.

(8) The above-described connectors of the control 70 are arranged at opposite ends of the control unit 70 in the lamination direction of the battery cell 21. Therefore, without expanding size of the substrate member 71, appropriate arrangement of the respective connectors can be made.

The present disclosure is not limited to the above-described contents of the embodiment. The embodiment can be modified in the following manner.

(Modifications)

In a configuration where the protrusions 26a and 26b are not disposed, the cell monitor substrate 60 and the control unit 70 can be arranged in an available space formed in a lateral side of the bus bar unit 30. Even in this case, it is possible to reduce dead space in the space where the battery pack unit 10 is disposed.

The protrusions 26a and 26b may be arranged outward the bus bar unit 30 (electrode terminal 23). In this case, depending on the height of the electrode surface 21a, the respective substrates are supported by either bus bar unit 30 or the protrusions 26a or 26b.

In the embodiment, the respective substrates are mounted in the available space on the battery pack unit 20 such that the mounted surface of the substrates face towards the battery pack 20. Other than this, the respective substrates can be mounted on the available space of the battery pack 20 such that the mounted surface of the above-described substrates faces upward. For example, when the available space (in the height direction) of the electrode surface 21a side of the battery pack unit 20 is sufficiently secured, even if the respective substrates are mounted such that the mounted surface faces upward, space saving can be made without increasing the height of the battery pack unit 10. Moreover, when the available space of the electrode surface 21a side of the battery pack 20 is sufficiently secured, the above-described respective substrates with the electrical components 62 and 72 disposed thereon can be mounted to the battery pack unit 10. In this case, when the available space is sufficiently secured on the electrode surface 21a, the respective substrates can be mounted such that either side of the substrate faces the battery pack 20 side. Furthermore, a surface on which electrical components 62 and 72 having higher height are disposed may be disposed to face the battery pack 20 so as to have the available space utilized more effectively.

What is claimed is:

1. A battery pack unit comprising:
a plurality of battery cells each having an electrode and a side surface;
a battery pack constituted by the plurality of battery cells being laminated in a lamination direction wherein the side surface of each battery cell faces the side surface of a battery cell being adjacent to the each battery cell and, the electrode of the each battery cell and the electrode of the battery cell being adjacent to the each battery cell are arranged in the same side thereof;
an electrode connecting member disposed at a side of an electrode surface of the battery pack in which electrodes of the plurality of battery cells are arranged, the electrode connecting member electrically connecting electrodes of mutually adjacent battery cells in the plurality of battery cells, thereby connecting the plurality of battery cells to be in series;
a cell monitor substrate that monitors a state of every battery cell in the plurality of battery cells; and
a control unit electrically connected to the cell monitor substrate, receiving a signal transmitted from the cell monitor substrate, wherein
the cell monitor substrate and the control unit are arranged in the lamination direction and arranged in parallel with the electrode connecting member at the side of the electrode surface.

2. The battery pack unit according to claim 1, wherein
the battery cell has an end surface portion having a rectangular shape;
a pair of electrodes are disposed at opposite end portions of the end surface portion in a longitudinal direction being perpendicular to the lamination direction;
the electrode connecting member is configured as a bus bar unit provided with a bus bar that electrically connects electrodes of the battery cells which are adjacent to each other and a bus bar casing in which a plurality of bus bars are arranged in a row;
the bus bar unit is disposed at opposite end portions of the end surface portion; and
the cell monitor substrate and the control unit are disposed between the bus bar units which are disposed at the opposite end portions.

3. The battery pack unit according to claim 1, wherein
a protrusion is formed at the side of the electrode surface to couple the plurality of battery cells to be integrated with each other; and
the protrusion supports the cell monitor substrate and the control unit.

4. The battery pack unit according to claim 2, wherein
a protrusion is formed at the side of the electrode surface to couple the plurality of battery cells to be integrated with each other; and
the protrusion supports the cell monitor substrate and the control unit.

5. The battery pack unit according to claim 1, wherein
the control unit is disposed on the side of the electrode surface to be sandwiched by two cell monitor substrates.

6. The battery pack unit according to claim 2, wherein
the control unit is disposed on the side of the electrode surface to be sandwiched by two cell monitor substrates.

7. The battery pack unit according to claim 3, wherein
the control unit is disposed on the side of the electrode surface to be sandwiched by two cell monitor substrates.

8. The battery pack unit according to claim 1, wherein
the cell monitor substrate and the control unit are electrically connected via a wire harness;
a first connector is disposed at the cell monitor substrate and the control unit, and a second connector is disposed at the wire harness, the second connector being capable of detaching or attaching from/to the first connector; and
the first connector and the second connector are disposed in the lamination direction such that the second connector is attached or detached in the lamination direction.

9. The battery pack unit according to claim 2, wherein
the cell monitor substrate and the control unit are electrically connected via a wire harness;
a first connector is disposed at the cell monitor substrate and the control unit, and a second connector is disposed at the wire harness, the second connector being capable of detaching or attaching from/to the first connector; and
the first connector and the second connector are disposed in the lamination direction such that the second connector is attached or detached in the lamination direction.

10. The battery pack unit according to claim 3, wherein
the cell monitor substrate and the control unit are electrically connected via a wire harness;
a first connector is disposed at the cell monitor substrate and the control unit, and a second connector is disposed at the wire harness, the second connector being capable of detaching or attaching from/to the first connector; and
the first connector and the second connector are disposed in the lamination direction such that the second connector is attached or detached in the lamination direction.

11. The battery pack unit according to claim 5, wherein
the cell monitor substrate and the control unit are electrically connected via a wire harness;
a first connector is disposed at the cell monitor substrate and the control unit, and a second connector is disposed at the wire harness, the second connector being capable of detaching or attaching from/to the first connector; and
the first connector and the second connector are disposed in the lamination direction such that the second connector is attached or detached in the lamination direction.

12. The battery pack unit according to claim 8, wherein
the cell monitor substrate and the control unit are disposed to be apart from each other to make a gap therebetween;
a connecting portion of the first connector at the cell monitor substrate and a connecting portion of the first connector at the control unit face from each other; and
the gap between the cell monitor substrate and the control unit allows the second connector to detach or attach from/to the second connector.

13. The battery pack unit according to claim 8, wherein
the cell monitor substrate is provided with a battery connector, as a first connector, at either one end of both end portions of the cell monitor substrate in the lamination direction, the battery connector being electrically connected to the battery pack; and
the cell monitor substrate is provided with a substrate connector, as a first connector, at the other side of both end portions of the cell monitor substrate in the lamination direction, the substrate connector being electrically connected to a substrate other than an own substrate.

14. The battery pack unit according to claim 8, wherein
the control unit is provided with a separated substrate connector, as a first connector, at either one end of both end portions of the control unit in the lamination direction, the separated substrate connector being electrically connected to equipment other than the battery pack; and
the control unit is provided with an other substrate connector, as a first connector, at the other side of both end portions of the control unit in the lamination direction, the other substrate connector being electrically connected to the cell monitor substrate.

15. The battery pack unit according to claim 8, wherein
the cell monitor substrate and the control unit include a substrate member that is disposed facing the battery pack, an electrical component being mounted on one surface of the substrate member and the first connector;
the substrate member is supported by the protrusion such that a mounted surface on which the electrical component and the first connector are disposed faces a side of the battery cell.
